(19) United States
(12) Patent Application Publication
(10) Pub. No.: US 2020/0014740 A1
(43) Pub. Date: Jan. 9, 2020

(54) TILE STREAM SELECTION FOR MOBILE BANDWITH OPTIMIZATION

(71) Applicant: Avigilon Corporation, Vancouver (CA)

(72) Inventors: Jimmy Hsin-Chia Chao, Burnaby (CA); Brummell Paul L. Elgincolin, Burnaby (CA); Qiang Lai, Vancouver (CA); Shaun P. Marlatt, North Vancouver (CA); Pao-Hsuan Wu, Delta (CA)

(73) Assignee: Avigilon Corporation, Vancouver (CA)

(21) Appl. No.: 16/029,482

(22) Filed: Jul. 6, 2018

(51) Int. Cl. H04L 29/06; H04N 7/18; H04N 21/4402

(52) U.S. Cl. CPC H04L 65/601; H04N 21/4402; H04N 7/181

(57) ABSTRACT

Tile stream selection for mobile bandwidth optimization is disclosed. Also disclosed is a method that includes storing a plurality of video tiles combinable to form a larger portion or all of a high resolution video. The method also includes processing a request to stream at least a first video tile of the video tiles. The processing includes determining a size of a first portion of a region of interest falling within the first video tile; determining whether the size of the first portion is below a threshold size; and transmitting, over at least one network, a first video stream that includes the first video tile. The first video tile is transmitted in: a first resolution when the size of the first portion is below the threshold size; and a second resolution when the size of the first portion is above the threshold size.

### FIELD

The present subject-matter relates to mobile bandwidth optimization in video-related applications and, in particular, to tile stream selection for mobile bandwidth optimization.

### BACKGROUND

Data usage in smart phones and cellular-enabled devices can be expensive and possibly subject to overage charges. Watching high definition video at high frame rates on such devices over the cellular network consumes a lot of data. Systems can implement processing modules to convert high definition video formats into more compressed video formats to reduce the data consumption; however video quality may be significantly impacted, which can lead to an overall poorer user experience.

To keep device size and power consumption small, typically smart phones and cellular-enabled devices have limitations in processor power and available memory, which prevents watching multiple high definition streams simultaneously. That being said, smart phone technology has certainly reached the point where certain types of high definition streams can be watched simultaneously.

### SUMMARY

According to one example embodiment, there is provided a surveillance system that includes a plurality of video security cameras and a server system communicatively coupled to the video security cameras. The server system includes a stream manager and at least one computer-readable storage device configured to store a plurality of video tiles combinable to form a larger portion or all of a high resolution video recorded by one of the video security cameras. The stream manager is configured to process a request to stream at least a first video tile of the video tiles. The processing of the request by the stream manager includes: determining a size of a first portion of a region of interest falling within the first video tile; determining whether the size of the first portion is below a threshold size; and initiating transmission of a first video stream over at least one network that includes at least one wireless communications path. The first video stream includes the first video tile, and the server system is configured to transmit the first video stream in: a first resolution when the size of the first portion is below the threshold size; and a second resolution when the size of the first portion is above the threshold size. The second resolution is higher than the first resolution.

According to another example embodiment, there is provided a method that includes storing a plurality of video tiles combinable to form a larger portion or all of a high resolution video. The method also includes processing a request to stream at least a first video tile of the video tiles. The processing includes determining a size of a first portion of a region of interest falling within the first video tile; determining whether the size of the first portion is below a threshold size; and transmitting, over at least one network, a first video stream that includes the first video tile. The first video tile is transmitted in: a first resolution when the size of the first portion is below the threshold size; and a second resolution when the size of the first portion is above the threshold size. The second resolution being higher than the first resolution.

According to yet another example embodiment, there is provided a tangible, non-transitory, computer-readable storage medium deployable within a server system that acts on a plurality of video tiles such that the video tiles are combinable to form a larger portion or all of a high resolution video. The computer-readable storage medium has instructions encoded therein, wherein the instructions, when executed by at least one processor, cause a carrying out of a method that includes processing a request to stream at least a first video tile of the video tiles. The processing including: determining a size of a first portion of a region of interest falling within the first video tile; determining whether the size of the first portion is below a threshold size; and transmitting, over at least one network, a first video stream that includes the first video tile. The first video tile is transmitted in: a first resolution when the size of the first portion is below the threshold size; and a second resolution when the size of the first portion is above the threshold size. The second resolution being higher than the first resolution.

### BRIEF DESCRIPTION OF THE DRAWINGS

Reference will now be made, by way of example, to the accompanying drawings:

FIG. 1 shows a block diagram of an example surveillance system within which methods in accordance with example embodiments can be carried out;

FIG. 2 shows a block diagram illustrating more details of a camera-side part of the example surveillance system shown in FIG. 1;

FIG. 3 shows a block diagram illustrating more details of a mobile device-side part of the example surveillance system shown in FIG. 1;

FIG. 4 shows a block diagram illustrating buffering within a mobile computing device to support tile streaming synchronization in accordance with an example embodiment;

FIG. 5 is a flow chart of a stream retrieval method in accordance with at least one example embodiment;

FIG. 6 is a block diagram illustrating tiling in accordance with an example embodiment;

FIG. 7 is a flow chart of a stream resolution determination method in accordance with at least one example embodiment; and

FIG. 8 is a block diagram illustrating a user pan movement where an ROI moves from an original position, shown in FIG. 6, to a new position.

Similar or the same reference numerals may have been used in different figures to denote similar example features illustrated in the drawings.

### DETAILED DESCRIPTION OF EXAMPLE EMBODIMENTS

It will be understood that when an element is herein referred to as being “connected”, “in communication with” or “coupled” to another element, it can be directly connected, directly in communication with or directly coupled to the other element or intervening elements may be present. In contrast, when an element is herein referred to as being “directly connected”, “directly in communication with” or “directly coupled” to another element, there are no intervening elements present. Other words used to describe the relationship between elements should be interpreted in a like fashion (i.e., “between” versus “directly between”, “adjacent” versus “directly adjacent”, etc.).

As will be appreciated by one skilled in the art, the various example embodiments described herein may be embodied as a method, system, or computer program product. Any suitable computer-usable or computer readable medium may be utilized. The computer-usable or computer-readable medium may be, for example but not limited to, an electronic, magnetic, optical, electromagnetic, infrared, or semiconductor system, apparatus, device, or propagation medium. In the context of this document, a computer-usable or computer-readable medium may be any medium that can contain, store, communicate, propagate, or transport the program for use by or in connection with the instruction execution system, apparatus, or device.

Computer program code for carrying out operations of various example embodiments may be written in an object oriented programming language such as Java, Smalltalk, C++ or the like. However, the computer program code for carrying out operations of various example embodiments may also be written in conventional procedural programming languages, such as the “C” programming language or similar programming languages. The actual programming language selected is a matter of design choice and, as will be appreciated by those skilled in the art, any suitable programming language can be utilized.

Various example embodiments are described below with reference to flowchart illustration(s) and/or block diagrams of methods, apparatus (systems) and computer program products according to embodiments of the invention. Those skilled in the art will understand that various blocks of the flowchart illustration(s) and/or block diagrams, and combinations of blocks in the flowchart illustration(s) and/or block diagrams, can be implemented by computer program instructions. These computer program instructions may be provided to a processor of a general purpose computer, special purpose computer, or other programmable data processing apparatus to produce a machine, such that the instructions, which executed via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The term “high resolution” as used herein refers to videos or images that one skilled in the art would understand to have quantifiably greater sharpness and detail than other possible resolutions that can be practically provided by the technology tasked to generate and/or display the high resolution videos or high resolution images as the case may be. In some but not all examples, high resolution is 1080p or greater. Similarly the term “low resolution” as used herein refers to videos or images that one skilled in the art would understand to have quantifiably lower sharpness and detail than other possible resolutions that can be practically provided by the technology tasked to generate and/or display the low resolution videos or low resolution images as the case may be. In some but not all examples, low resolution is a resolution that is lower than 1080p. Also, it will be understood that display resolutions capabilities increase over time and, as technology evolves, it is expected that more and more displays will have display resolutions capabilities so great that display resolutions beyond the visual acuity of human user will become common place. 4K large format (TV) displays, which are now widely available to consumers, are pretty much on the edge of human visual acuity, and 8K large format displays are on the horizon. Similarly, smaller displays (including those found on mobile computing devices) are experiencing this same trend over time, but it must also be kept in mind that, all other factors being equal, visual acuity will be exceeded faster on a smaller screen than on a larger screen. Bringing this concept of visual acuity within the context of an illustrative example, it may be objectively wasteful to effect entire display of a 30 MP video on a 4 inch display of a smartphone since the pixel density will be beyond the visual acuity of the human user; however the same statement is not true in regards to effecting entire display of the same 30 MP video on a 100 inch television screen.

In accordance with a number of example embodiments, video data is transmitted to a mobile computing device over at least one network. This mobile computing device that receives video data need not necessarily be a latest generation device (it may be an earlier generation device). As will be appreciated by those skilled in the art, earlier generations devices may have more limitations in capability than a latest generation device. For example, one notable limitation may be the maximum resolution of a memory surface. As will be understood by one skilled in the art, a memory surface is an allocated memory buffer that a graphics Application Programming Interface (API) allows someone to address in two dimensions (x,y). The underlying memory layout for the storage of a memory surface is abstracted by the graphics hardware. A user can, for example, just specify the width, height, and pixel format. For example, a pixel format might take a form that is basically like ARGB32—which is an RGB pixel with transparency (Alpha), with 8-bits allocated per color channel [Alpha:8, Red:8, Green:8, Blue:8].

Also, three-dimensional graphics hardware has limits on the maximum dimensions of a two-dimensional image buffer that they will allocate (usually powers of two such as, for example, 2048×2048, 4096×4096, 8192×8192, etc.). Graphics APIs may expose abstractions that look like the following:

buff1D=AllocateMemory1D(length)

buff2D=AllocateMemory2D(width,height)

buff3D=AllocateMemory3D(width,height,depth)

These are Addressable:

sample=buff1D[x]

pixel=buff2D[x][y]

voxel=buff3D[x][y][z]

The capabilities of the hardware place limits on the maximum dimensions of these allocations. In this regard (and for the purpose of illustrating the issue) say for example that an earlier generation smart phone has a memory surface of 2048×2048, then a latest generation smart phone may have a higher memory surface, say 4096×4096 for example. A video encoding exceeding these dimensions will not be decodable on those cell phones. Nevertheless, breaking the encoding into tiles which are smaller than these resolutions should allow all smart phones to access higher-resolution representations (even if in some cases only decode one or two tiles may be decoded).

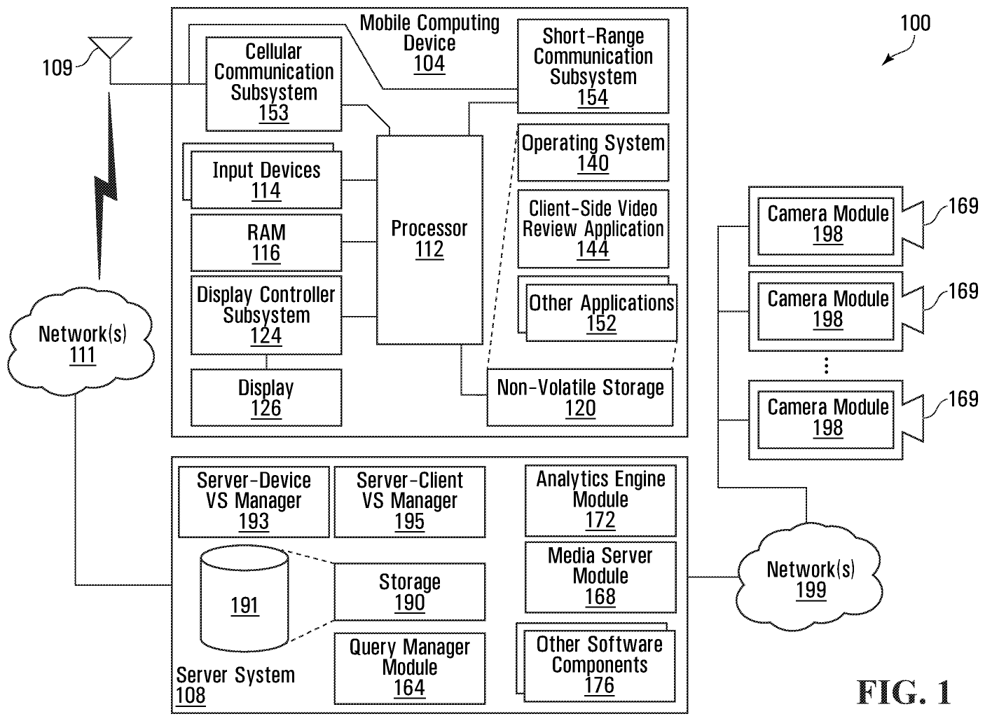

Reference is now made to FIG. 1 which shows a block diagram of an example surveillance system 100 within which example embodiments may be implemented and methods in accordance with example embodiments may be carried out. Included within the illustrated surveillance system 100 are one or more mobile computing devices 104 and a server system 108. In accordance with at least some example embodiments, the mobile computing device 104 is a selected one or more of the following: a handheld device such as, for example, a tablet, a phablet, a smart phone or a personal digital assistant (PDA); a laptop computer; a netbook; and other suitable mobile computing devices. With respect to the server system 108, this could comprise a single physical machine or multiple physical machines (which may or may not be co-located at one location). It will be understood that the server system 108 need not be contained within a single chassis, nor necessarily will there be a single location for the server system 108. As will be appreciated by those skilled in the art, at least some of the functionality of the server system 108 can be implemented within the mobile computing device 104 rather than within the server system 108.

As illustrated in FIG. 1, the mobile computing device 104 communicates with the server system 108 via antenna(s) 109 and through one or more networks 111. The network(s) 111 can include any suitable combination of individual networks that may include a part of the Internet, or one or more other public/private networks coupled together by network switches or other communication elements. The network(s) 111 could be of the form of, for example, client-server networks, peer-to-peer networks, etc. Data connections between the mobile computing device 104 and the server system 108 can be any number of known arrangements for accessing a data communications network, such as, for example, dial-up Serial Line Interface Protocol/Point-to-Point Protocol (SLIP/PPP), Integrated Services Digital Network (ISDN), dedicated lease line service, broadband (e.g. cable) access, Digital Subscriber Line (DSL), Asynchronous Transfer Mode (ATM), Frame Relay, or other known access techniques (for example, radio frequency (RF) links). In at least one example embodiment, the mobile computing device 104 and the server system 108 are within the same Local Area Network (LAN).

The mobile computing device 104 includes at least one processor 112 that controls the overall operation of the mobile computing device 104. The processor 112 interacts with various subsystems such as, for example, input devices 114 (such as a selected one or more of a keyboard, mouse, touch pad, roller ball and voice control means, for example), random access memory (RAM) 116, non-volatile storage 120, display controller subsystem 124 and other subsystems that are not shown. The display controller subsystem 124 interacts with display 126 and it renders graphics and/or text upon the display 126.

Still with reference to the mobile computing device 104 within the surveillance system 100, operating system 140 and various software applications used by the processor 112 are stored in the non-volatile storage 120. The non-volatile storage 120 is, for example, one or more hard disks, solid state drives, or some other suitable form of computer readable medium that retains recorded information after the mobile computing device 104 is turned off (or enters into a power mode where no power is being delivered to memory/storage). Regarding the operating system 140, this includes software that manages computer hardware and software resources of the mobile computing device 104 and provides common services for computer programs. Also, those skilled in the art will appreciate that the operating system 140, client-side video review application 144, and other applications 152, or parts thereof, may be temporarily loaded into a volatile store such as the RAM 116. The processor 112, in addition to its operating system functions, can enable execution of the various software applications on the mobile computing device 104.

Still with reference to FIG. 1, the mobile computing device 104 also includes a cellular communication subsystem 153 and a short-range communications subsystem 154. Communication functions, including data and voice communications, are performed through the cellular communication subsystem 153 and through the short-range communications subsystem 154. Both the cellular communication subsystem 153 and the short-range communications subsystem 154 are capable of receiving and transmitting, in respect of their communication functions, via the antenna(s) 109. The specific design and implementation of the cellular communication subsystem 153 is dependent upon the communication network in which the mobile communications device 104 is intended to operate. For example, the cellular communication subsystem 153 of the mobile communications device 104 may be designed to operate with the Mobitex™, DataTAC™ or General Packet Radio Service (GPRS) mobile data communication networks and also designed to operate with any of a variety of voice communication networks, such as Advanced Mobile Phone Service (AMPS), Time Division Multiple Access (TDMA), Code Division Multiple Access (CDMA), Personal Communications Service (PCS), Global System for Mobile Communications (GSM), etc. Other types of data and voice networks, both separate and integrated, may also be utilized with the mobile device 104.

The cellular communication subsystem 153 can process a received signal, such as a text message, video stream or web page download, for input to the processor 112. The received signal is then further processed by the processor 112 for output to the display 126, for example. A device user may also compose data items, such as e-mail messages, using one or more of the input devices 114. The composed data items may then be transmitted over a wireless carrier network via the cellular communication subsystem 153. Transmission of other types of data items is contemplated. For instance, take the example of a user that employs the input devices 114 to interact with a User Interface (UI) of the client-side video review application 144. Data commands, derived from the user input received through the UI, are an example of the above-mentioned other types of transmitted data items.

Overall operation of the mobile communications device 104 in a voice communication mode may be substantially similar to operation in the data communication mode, except that received signals are output to a speaker of the mobile communications device 104, and signals for transmission are generated by a microphone of the mobile communications device 104. Alternative voice or audio I/O subsystems, such as a voice message recording subsystem, may also be implemented on the mobile communications device 104. In addition, the display 126 may also be utilized in voice communication mode, for example, to display the identity of a calling party, the duration of a voice call, or other voice call related information.

The short-range communications subsystem 154 enables communication between the mobile communications device 104 and other proximate systems or devices. For example, the illustrated short-range communications subsystem 154 may include a Bluetooth™ communication module to provide for communication with similarly-enabled systems and devices. As another example, the illustrated short-range communications subsystem 154 may include a Wi-Fi™ communication module to provide for communication with similarly-enabled systems and devices. As already mentioned, a user of the mobile communications device 104 may compose and/or otherwise generate data items. As an alternative to transmission over a wireless carrier network, the composed data items may be transmitted over a wireless local area network via the short-range communications subsystem 154. Also, those skilled in the art will appreciate that the mobile communications device 104 may obtain Global Positioning System (GPS) information and data through the cellular communication subsystem 153, the short-range communications subsystem 154 and/or a separate GPS receiver.

The server system 108 includes several software components for carrying out other functions of the server system 108. For example, the server system 108 includes a media server module 168. The media server module 168 handles client requests related to storage and retrieval of video taken by digital video cameras 169 in the surveillance system 100. The server system 108 also includes an analytics engine module 172. The analytics engine module 172 can, in some examples, be any suitable one of known commercially available software that carry out mathematical calculations (and other operations) to carry out video analytics related functions including, for example, tripwire, object left behind, etc. Although not illustrated, the server system 108 may also include a gateway module, which can reside between server device(s) a LAN and/or Wide Area Network (WAN). The gateway module may include functionality such as, for instance, protocol translation, reverse proxying, push notifications to clients, and firewall traversal.

The server system 108 also includes a number of other software components 176. These other software components will vary depending on the requirements of the server system 108 within the overall system. As just one example, the other software components 176 might include special test and debugging software, or software to facilitate version updating of modules within the server system 108. The server system 108 also includes one or more data stores 190. In some examples, the data store 190 comprises one or more databases 191 which facilitate the organized storing of recorded video. In the case where the server system 108 includes a plurality of data stores 190, some of the overall storage may be within a LAN and some other part of the overall storage may be within the cloud. Also, although the storage 190 is depicted within the server system 108, it will be understood that the storage 190 need not necessarily be located there. For example, it is contemplated that the storage 190 may alternative be coupled to the server system 108 via a network. For instance, the storage 190 may be in the cloud. In some examples, some part of the storage 190 may be provided by one or more so-called Network Video Recorders (NVRs).

The server system 108 also includes a server-device Virtual Stream (VS) manager 193 and a server-client VS manager 195, both of which are later herein described in more detail.

Regarding the digital video cameras 169, each of these includes a camera module 198. In some examples, the camera module 198 includes one or more specialized chips to facilitate processing and encoding of video before it is even received by the server system 108. For instance, the specialized chip may be a System-on-Chip (SoC) solution including both an encoder and a Central Processing Unit (CPU). These permit the camera module 198 to carry out the processing and encoding functions. Also, in some examples, part of the processing functions of the camera module 198 includes creating metadata for recorded video.

Video generated within any of the digital video cameras 169 may be transmitted to the server system 108 via one or more network(s) 199. The network(s) 199 can include any suitable combination of individual networks that may include a part of the Internet, or one or more other public/private networks coupled together by network switches or other communication elements. The network(s) 199 could be of the form of, for example, client-server networks, peer-to-peer networks, etc. Data connections between the video camera and the server system 108 can be any number of known arrangements for accessing a data communications network, such as, for example, dial-up SLIP/PPP, ISDN, dedicated lease line service, broadband (e.g. cable) access, DSL, ATM, Frame Relay, or other known access techniques (for example, RF links). In a number of example embodiments, the digital video cameras 169 and the server system 108 are within the same LAN.

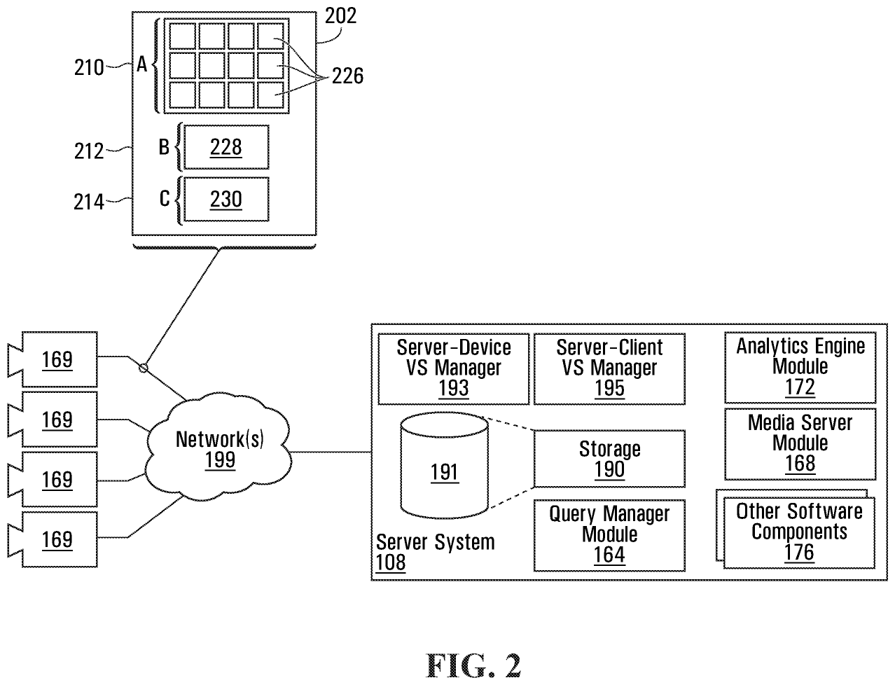

For the example embodiment illustrated in FIG. 1, each of digital video cameras 169 may be configured to provide various Virtual Stream (VS) encodings depending upon the capabilities of the respective digital video cameras 169, the capabilities of other components, such as the bandwidth of network 199, the bandwidth of network(s) 111, the available storage space as well as the requirements of the surveillance system 100, as well as other suitable parameters material to operation of the digital video cameras 169. The digital video cameras 169 may provide a single resolution encoding, or a plurality of individual resolution encodings. Further, each resolution encoding may be provided by a number of virtual streams. Stream 202 is depicted in FIG. 2 as being streamed from one of the digital video cameras 169 to the server system 108 over the network(s) 199.

As depicted, the stream 202 comprises a number of individual resolution encodings 210, 212, 214. The individual resolution encodings 210, 212, 214 are depicted as encoding the same portion of the source video, which is contemplated as being substantially all of the region of interest of one of the video cameras 169. For example, the resolution encoding 210 may be encoded to the full resolution of the source, the resolution encoding 212 may be encoded to a half of the source resolution and the resolution encoding 214 may be encoded to a quarter of the source resolution. Each of the individual resolution encodings 210, 212, 214 encodes the source video using a respective encoding format such as H.264, H.265 or MPEG-4. In alternative embodiments, instead of adjusting resolution, the stream 202 may be encoded by varying one or more different encoding parameters, such as frame rate and video quality, additionally or alternatively to resolution.

As eluded to above, different encodings are optionally using different codecs in accordance with at least one example embodiment. For example, a primary encoding may be H.265 and a secondary encoding may be H.264. An impact of different encodings using different codecs can be providing compatibility for mobile computing devices that may not support newer encoding formats. Also, as will be appreciated by those skilled in the art, within any one particular codec the codings may also vary by any adjustable parameter (such as, for example, quality/quantization, forward error correction, chroma format, bit-depth, etc.).

Each of the individual resolution encodings 210, 212, 214 may be provided by one or more virtual streams 226, 228, 230 within the stream 202. Each virtual stream 226, 228, 230 comprises at least a portion of the video source encoded at the compression level of the respective resolution encodings 210, 212, 214. As depicted, the full resolution encoding 210 is provided by a 3×4 tiling of virtual streams. Each of the 12 virtual streams 226 is encoded with the same encoding format, and when the 12 virtual streams are combined they provide the full resolution of the source video. In an alternative embodiment, different encoding formats or different encoding parameters can be used to encode any one or more of these 12 virtual streams. The resolution encoding 212 is depicted as being provided by a single virtual stream. Accordingly, the virtual stream 228 may have a resolution of, for example, of the video source. Similarly, the virtual stream 230 may have a resolution of, for example, % of the video source. Although described as providing a tiling of a larger area, the virtual streams do not necessarily need to form tiles; rather, each virtual stream may encode a particular region of interest, which may comprise the full source video, or a portion thereof. The various virtual streams may overlap the same region of interest, or encode non-overlapping portions of the source video.

The server-device VS manager 193 may receive streams from the digital video cameras 169, such as the stream 202. The server-device VS manager 193 may de-multiplex the virtual streams of individual resolution encodings 210, 212, 214 from the received stream 202, and the de-multiplexed virtual streams may be passed to the storage 190. Additionally, one or more of the virtual streams may be passed to the server-client VS manager 195 for streaming to the mobile computing device 104.

It will be understood that the storage 190 is configured to store the virtual streams of the resolution encodings. In at least one example, the storage 190 may store the video data in different storage sections or tiers to reduce the amount of storage required. Then, after some defined period of time has passed, it may be determined that the full resolution encoding is no longer required to be stored. The full resolution encoding may be removed from the storage 190, and the remaining resolution encodings stored in one of the storage tiers. Similarly, after some defined period of time, it may be determined that, for example, a medium resolution encoding is no longer required to be stored, and as such it can be removed from the storage 190 and any remaining resolution encoding is stored. In at least one example, the virtual streams are stored separately in each of a number of storage areas or tiers, and the age or length of time each virtual streams has been stored may be maintained independently. In such an example, after some defined period of time has passed, a container frame may be reconstructed from the virtual streams that remain stored in the storage 190.

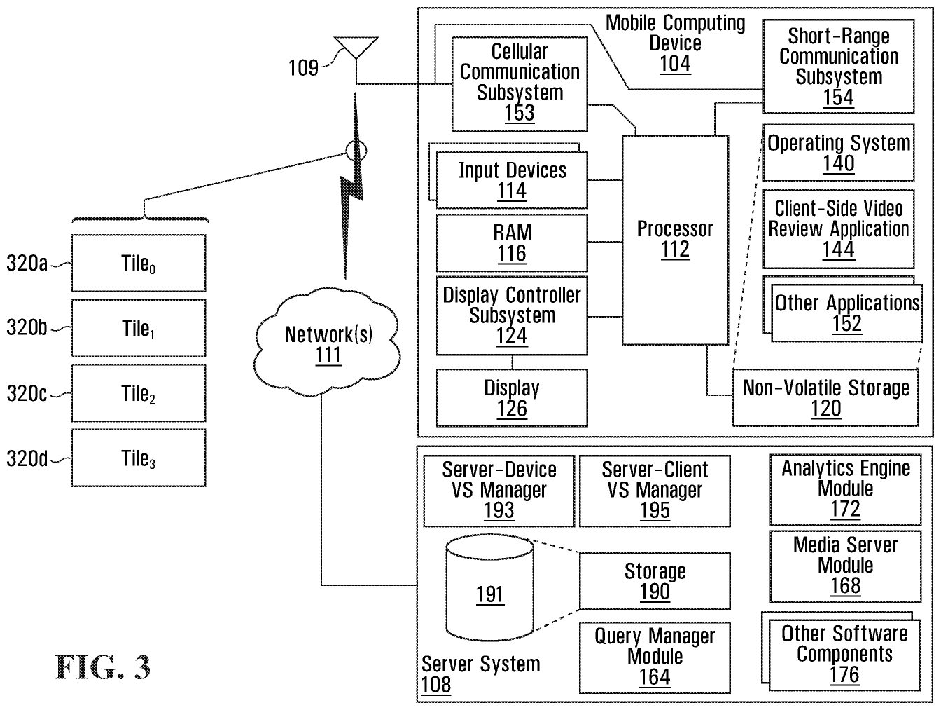

Reference will now be made to FIG. 3. As described above, the server-client VS manager 195 may receive resolution encodings from either the server-device VS manager 193 or the storage 190 for streaming to the mobile computing device 104 over the network(s) 111. The resolution encodings may be from different video source devices. Additionally, it is contemplated that the mobile computing device 104 can request a number of streams from the server-client VS manager 195, where each includes video packet data for a unique tile. These requests can identify the streams being requested through the use of Uniform Resource Identifier (URIs) as defined in Dynamic Adaptive Streaming over HTTP (DASH). Each stream has its own unique URI. A client can make a request for a virtual stream or individual resolution encoding using a URI. Each virtual stream or independent encoding has a unique URI. URIs can be further divided into shorter segments of time, such that a unique URI is associated with a virtual stream consisting of video frames in the interval (t_start, t_end). Clients can also use a different URI to query a manifest which describes the individual URIs for a particular camera (or cameras) over a given time period. For example, a client can query a DASH Media Presentation Description (MPD) which is an XML document that contains a listing of available virtual streams and encodings and the URIs that may be used to retrieve them.

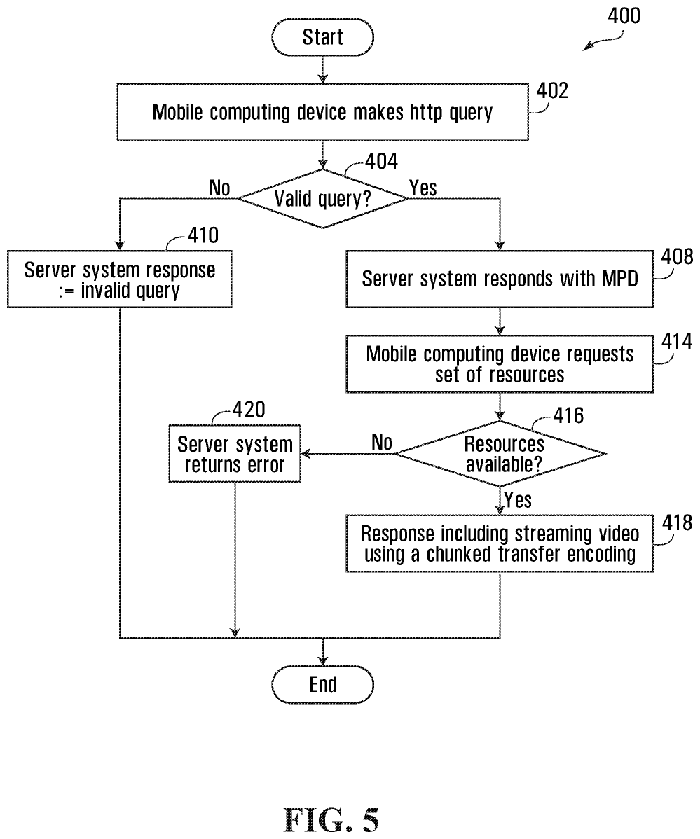

As shown in FIG. 3, requested streams 320a-320d each correspond to a respective one of tiles tile₀-tile₃. Retrieval may occur via, for example, Web Endpoint (web service endpoint is a Uniform Resource Locator at which clients of a specific service can gain access to it). A retrieval sequence in accordance with at least one example embodiment is described in more detail later herein with reference to a flow chart (FIG. 5).

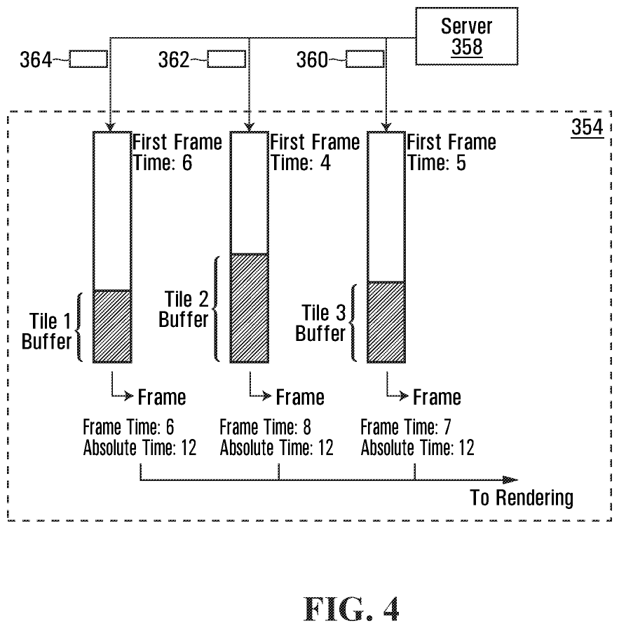

Reference will now be made to FIG. 4 which diagrammatically illustrates buffering within a mobile computing device 354 to support tile streaming synchronization in accordance with at least one example embodiment. In this diagrammatic illustration, the mobile computing device 354 may correspond to the mobile computing device 104 shown in FIG. 3, and similarly server system 358 may correspond to the server system 108 shown in more detail in FIG. 3. In the description of FIG. 4 which follow, reference will be made therein to presentation timestamp (PTS) and decode timestamp (DTS). PTS is used to synchronize displayed media (it informs as to when the frame needs to be presented within the presentation timeline). DTS is used to determine when to decode media (it informs as to the decode timeline). If frames are not reordered by the decoder, PTS may have the same value as DTS. However if, for example, B-Frames are present, the decoder order will be expected to be different from the presentation order, and PTS and DTS timestamps will differ. Table 1 below provides an illustrative example.

TABLE 1
Example Stream with B-frames

| Stream (Frame Type) | I | P | B | B |
|---|---|---|---|---|
| PTS | 1 | 4 | 2 | 3 |
| DTS | 1 | 2 | 3 | 4 |

Referring to FIG. 4, the mobile computing device 354 is requesting three tiles (“Tile 1”, “Tile 2” and “Tile 3”) from the server. When each stream is established, the server 358 will continuously send packets (e.g. packets 360, 362 and 364) to the mobile computing device 354 which, in terms of the Open Systems Interconnection (OSI) layers model, is occurring at the transport layer. In terms of presentation scheduling, buffering is generally occurring at the application layer on the receive side (video frames) since these contain the timing information, although buffering is not entirely limited to the application layer. One skilled in the art will understand that, in terms of the OSI layers model, the application layer is relating to the video frames, the presentation layer is relating to the container (MP4), the session layer is relating to chunked HTTP transport and the transport layer is relating to TCP transport.

Since a streaming protocol that contains absolute timing information is not being used, each frame only knows how far from the beginning of the stream they are at. Therefore, a frame that is supposed to be played at, for example, the 60th second from the start of the stream will have a “Frame Time” of 60 (note: the frame timing information described here is simplified for convenience of illustration and frame time is actually delivered as PTS and DTS). However, the 60th second of a stream that started at, for example, 1:00 pm and a stream that started at 1:01 pm are not the same time in the real world. One is captured at 1:01 pm and the other at 1:02 pm. To know if two frames with a “Frame Time” of 60 are referencing the same real world time, the server delivers the real world time of the very first frame being delivered. This is labelled in FIG. 4 as “First Frame Time” (note: the first frame time described here is simplified for convenience of illustration because the first frame time is actually delivered as an ISO8601 timestamp). Once this information is available, a calculation can be made, by adding “First Frame Time” to “Frame Time”, of the time that the frame is supposed to represent in real world time (labeled as “Absolute Time” in FIG. 4). Also, in an alternative example embodiment the mapping between the real-world time of the media and presentation time might be delivered in, for example, the ISOBMFF (mp4) container using the producer reference time box (‘prtf’) box as per Section 8.16.5 of the ISO/IEC 14496-12 publication (the content of that section is herein incorporated by reference).

Returning again to the presently described example embodiment, if two frames have the same “Absolute Time”, it means the frames are images that were captured at the same moment in real world time. As shown in FIG. 4, frames with the same “Absolute Time” timestamp can be sent concurrently for rendering. (As already mentioned, “Absolute Time” equals “First Frame Time” plus “Frame Time”.) Thus, these frames are sent together to the rendering engine so that they can be rendered at the same time. In the event some buffers may not have matching “Absolute Time”, the ones that do match are sent to be rendered while the unmatched ones are left in the buffers in the hopes that, at a later time, the ones that do not match will find matches. Of course, if no match is ultimately found and the “Absolute Time” of the unmatched frames have gone past, then the unmatched frames are discarded. This way there is confidence that any frames being sent to rendering share the same moment and users will not see two discontinuous frames being drawn at the same time.

FIG. 5 is a flow chart of a stream retrieval method 400 in accordance with at least one example embodiment. At the beginning of the retrieval sequence, the mobile computing device 104 makes an HTTP query (402). The HTTP query may be for the MPD XML document described in DASH that describes all available encodings of media for a specific device over a period of time, or in the special case of live, for an unbounded period. For each encoding, the MPD includes unique URI (or multiple URIs for time-segmented encodings) to retrieve it. Also, as will be understood by one skilled in the art, example embodiments are not limited to employing DASH manifest. For example, in at least one alternative example embodiment HTTP Live Streaming (HLS) may be employed where a manifest is provided in an m3u format. In this regard, the m3u format manifest is similar in content to the DASH manifest which is an XML document.

Following the HTTP query action 402, the server system 108 checks (404) whether the query can be satisfied. If yes, the server system 108 responds (408) with an MPD that satisfies the query. The DASH manifest (i.e. MPD) describes all properties necessary for the mobile computing device 104 to make a decision about which media resource(s) to request. If the query cannot be satisfied, the server system 108 responds (410) letting the mobile computing device 104 know that the HTTP query is invalid. Next, after the server system 108 has responded with the MPD, the mobile computing device 104 picks a set of resources and requests (414) the picked set of resources. This may include possibly having a specific time sought within the media using a URL query modifier. In at least one alternative example embodiment, a segment timeline or SIDX may be employed. It will be understood that SIDX is a table that maps presentation timestamps to byte-range requests on the URI resources described the DASH manifest. A segment timeline is a timeline that maps presentation times to unique URIs that retrieve smaller segments of video (such as, for example, a segment of video that is around ten seconds in duration).

Following the action 414 in the method 400, the server system 108 checks (416) whether or not the requested resources are available. If yes, the server system 108 may respond (418) with an ‘HTTP 200 OK’ which includes delivering stream video using a chunked transfer encoding. If the requested resources are available, then the server system 108 may respond (420) with an appropriate error message.

Example software code corresponding to actions in the method 400 are provided in Table 2 below,

TABLE 2
Example Software Code for the Method 400

| Action | |
|---|---|
| Reference | |
| Numeral (as | |
| Labelled in | |
| the Flow | |
| Chart) | Example Software Code |
| 402 | https://<hostname>/mt/api/rest/v1/media?session=<sessionld>& |
| | camerald=<camerald>&media=video&format=mpd&t=20180524T180848 |
| | .000Z,g |
| 408 | 1. HTTP OK |
| | 2. {‘content-type’: ‘application/dash+xml’, ‘server’: ‘AccServer/6.10’, |
| | . . .} |
| | <HTTP BODY with DASH XML Manifest> |
| | (Note: manifest which contains the URI that is retrieved in 414 is shown |
| | below.) |
| | <?xml version=“1.0” encoding=“UTF-8”?> |
| | <MPD xmlns=“urn:mpeg:dash:schema:mpd:2011” |
| | xmlns:xsi=“http://www.w3.org/2001/XMLSchema-instance” |
| | xmlns:xsd=“http://www.w3.org/2001/XMLSchema” |
| | xmlns:mpd=“urn:mpeg:dash:schema:mpd:2011” |
| | xmlns:xlink=“http://www.w3.org/1999/xlink” |
| | profiles=“urn:mpeg:dash:profile:isoff-on-demand:2011” type=“static” |
| | availabilityStartTime=“2018-05-24T18:08:16Z” |
| | minBufferTime=“PT1.5S”> |
| | <Period duration=“PT66S”> |
| | <AdaptationSet> |
| | <SupplementalProperty schemeldUri=“urn:mpeg:dash:srd:2014” |
| | value=“0,0,0,2592,1944,2592,1944”/> |
| | <Role schemeldUri=“urn:mpeg:dash:role:2011” value=“main”/> |
| | <Representation id=“2” bandwidth=“1440000” width=“800” height=“600” |
| | mimeType=“video/mp4”> |
| | <BaseURL>/mt/api/rest/v1/media?ctx=U9LPTU3JTNRPSU1LLM0p0TfU |
| | MzAwtLAwNTQwTDZO0ktOzDUw0C9KTQ4qN3CEAlv9kqLE5GygCj0DP |
| | UP7tPyi3MQS27TcAhMIAA</BaseURL> |
| | </Representation> |
| | <Representation id=“3” bandwidth=“921600” width=“640” height=“480” |
| | mimeType=“video/mp4”> |
| | <BaseURL>/mt/api/rest/v1/media?ctx=U9LPTU3JTNRPSU1LLM0p0TfU |
| | MzAwtLAwNTQwTDZO0ktOzDUw0C9KTQ4qN3CEAlv9kqLE5GygCj0DP |
| | SP7tPyi3MQS27TcAhMIAA</BaseURL> |
| | </Representation> |
| | </AdaptationSet> |
| | <AdaptationSet> |
| | <SupplementalProperty schemeldUri=“urn:mpeg:dash:srd:2014” |
| | value=“0,0,0,864,648,2592,1944”/> |
| | <Role schemeldUri=“urn:mpeg:dash:role:2011” value=“supplementary”/> |
| | <Representation id=“1” bandwidth=“1679616” width=“864” height=“648” |
| | mimeType=“video/mp4”> |
| | <BaseURL>/mt/api/rest/v1/media?ctx=U9LPTU3JTNRPSU1LLM0p0TfU |
| | MzAwtLAwNTQwTDZO0ktOzDUw0C9KTQ4qN3CEAlv9kqLE5GygCj0DP |
| | QP7tPyi3MQS27TcAhMIAA</BaseURL> |
| | </Representation> |
| | </AdaptationSet> |
| | <AdaptationSet> |
| | <SupplementalProperty schemeldUri=“urn:mpeg:dash:srd:2014” |
| | value=“0,864,0,864,648,2592,1944”/> |
| | <Role schemeldUri=“urn:mpeg:dash:role:2011” value=“supplementary”/> |
| | <Representation id=“4” bandwidth=“1679616” width=“864” height=“648” |
| | mimeType=“video/mp4”> |
| | <BaseURL>/mt/api/rest/v1/media?ctx=U9LPTU3JTNRPSU1LLM0p0TfU |
| | MzAwtLAwNTQwTDZO0ktOzDUw0C9KTQ4qN3CEAlv9kqLE5GygCj0DP |
| | RP7tPyi3MQS27TcAhMIAA</BaseURL> |
| | </Representation> |
| | </AdaptationSet> |
| | </Period> |
| | </MPD> |
| 414 | GET https://<hostname>/mt/api/rest/v1/media?ctx= |
| | U9LPTU3JTNRPSU1LLM0p0TfUMzAwtLAwNTQwTDZO |
| | 0ktOzDUw0C9KTQ4qN3CEAlv9kqLE5GygCj0DPUP7tPy |
| | i3MQS27TcAhMIAA&t=20180524T180848.000Z,g |
| | (Note: this is the URI to the video resource described by the dash manifest |
| | returned in 408. The query parameter “t=20180524T180848.000Z,g” is |
| | appended by the client to seek to that absolute timestamp within the |
| | requested resource. If that parameter is not appended then the behavior |
| | of the server is to stream from the beginning of the video associated with |
| | the URI.) |
| 418 | 1. HTTP 200 OK |
| | 2. {‘content-type’: ‘video/mp4’, ‘transfer-encoding’: ‘chunked’, ‘server’: |
| | ‘AccServer/6.10’, ‘x-avg-media-time’: ‘20180524T180848.254Z’, . . .} |
| | <HTTP BODY sent as a FMP4 chunked content stream> |

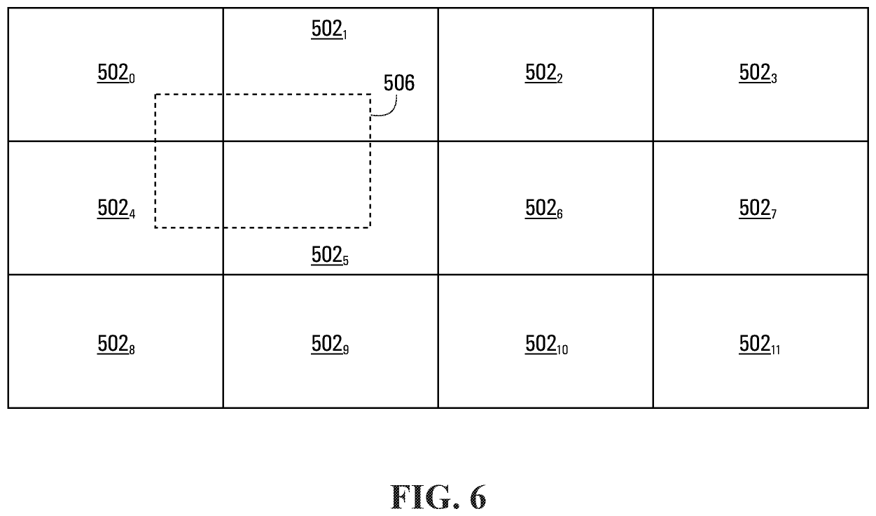

Reference will now be made to FIG. 6 which diagrammatically depicts tiling and bandwidth management of a video in accordance with an example embodiment. As shown, the video may be seen as split into 12 independent tiles 502₀-502₁₁. In regards to the format of the tiles 502₀-502₁₁, they all can be of the same format; however this is not a requirement and it will be understood that different tiles amongst the 12 can have different formats. Also, although there are 12 independent tiles 502₀-502₁₁ shown in the illustrated example embodiment, the exact number of tiles will vary depending upon the application. Any suitable number of tiles arranged in any suitable x by y arrangement (where x and y are positive integers greater than 0) of rows and columns is contemplated.

Region of Interest (ROI) 506 is indicated diagrammatically in FIG. 6 as dashed lines and is composed of four sub-regions, each of which is dimensionally defined by two edges of the ROI 506 and two of four tile edges. Also, each of the four sub-regions is a portion of one of the tiles 502₀, 502₁, 502₄ and 502₅. Now suppose a width and/or height of the ROI portion of the tile 502₀ is too small (i.e. below some threshold that the ROI portions do not fall below). In such case the mobile computing device 104 selects a lower stream resolution for the tile 502₀ as compared to stream resolution selected for the ROI portions of the tile 502₁, 502₄, and 502₅ which, unlike the tile 502₀ sub-region, may have sufficiently large widths and/or heights.

Also, example embodiments are not limited to just one high-to-low stream threshold of the type described above. It is contemplated that there could be a plurality of high-to-low stream thresholds. For example, below a first low threshold in a bottom range, the stream resolution is at low resolution. Then in a middle range, which would be above the first low threshold but below a second threshold, the stream resolution is higher than in the bottom range but below a high resolution of a top range, and the top range being where the width and/or height of the ROI portion of the tile is sufficiently large such that both first and second thresholds are exceeded. Also, it will be understood that example embodiments are not limited to just two or three resolution selection ranges as described above. Any suitable number of resolution selection ranges are contemplated.

In accordance with at least one example embodiment, a rule can be placed on the size of the ROI to restrict allowing tile streaming to occur only when the ROI is sufficiently small. For example, tile streaming may be only allowed only when both dimensions of the ROI are no greater than the respective dimensions of a single tile. The impact of this rule is ensuring that the ROI cannot include parts of more than four tiles at any one time. Also, those skilled in the art will appreciate that zoom level may impact whether streaming becomes/remains activated. Specifically zoom level is inversely related to ROI size, as the zoom level becomes higher the ROI size becomes smaller and vice versa. As an example of streaming becoming activated, when zoom level is increased from a first level where at least one dimension of the ROI is greater than respective dimensions of a tile to a second level where both dimensions of the ROI are no greater than the respective dimensions of a tile, a switch from full-frame video display to tile streaming may be triggered. As an example of streaming becoming de-activated, when zoom level is decreased from a first level where both dimensions of the ROI are no greater than the respective dimensions of a tile to a second level where at least one dimension of the ROI is greater than respective dimensions of a tile, a switch from tile streaming to full-frame video display may be triggered.

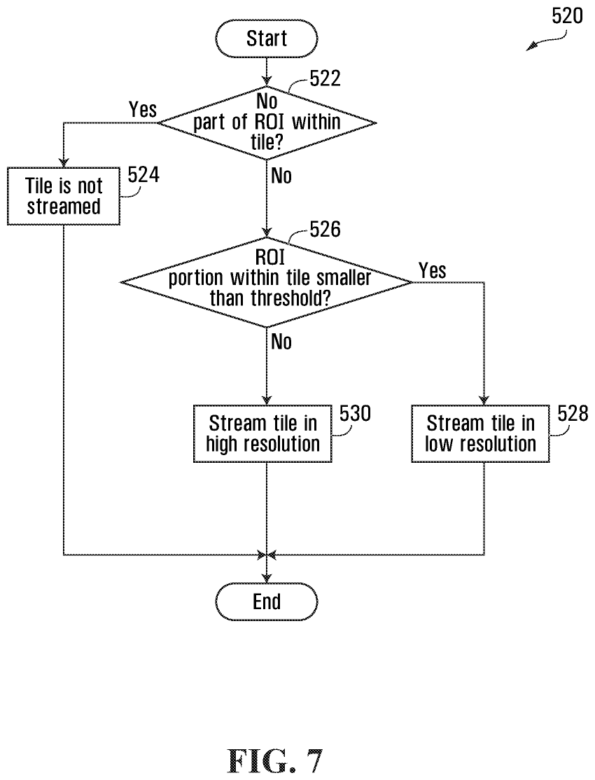

Reference will now be made to FIG. 7 which is a flow chart of a stream resolution determination method 520 in accordance with at least one example embodiment. At the beginning of the method 520, a tile is firstly analyzed (522) to make a determination as to whether not any part of the ROI falls within that tile. If no part of the ROI falls within the analyzed tile, then that tile is excluded (524) and not streamed. If at least some part of the ROI falls within the analyzed tile, then that tile is secondly analyzed (526) to make a determination as to whether not the ROI portion within the tile is smaller than a threshold (i.e. the threshold previously herein described). If the ROI portion within the tile is smaller than the threshold, then that tile is streamed (528) in low resolution. If the ROI portion within the tile is not smaller than the threshold, then that tile is streamed (530) in high resolution.

The method 520 may be carried out repeatedly with respect to each tile forming a part of the divided whole of the original video.

It will be understood that the ROI will vary to a great degree as the user of the mobile computing device 104 (FIGS. 1 and 3) pans along the display 126 (device screen) or adjusts the zoom scale. Therefore, at any given moment, there is a significant chance that the tiles (in which there is an ROI portion) satisfy the requirement for selectively switching to a lower resolution stream. Thus, screen density at a particular moment in time is relevant in the calculation and re-calculation of selection of stream resolution. In relation to pan movement, one example of ROI change is provided below.

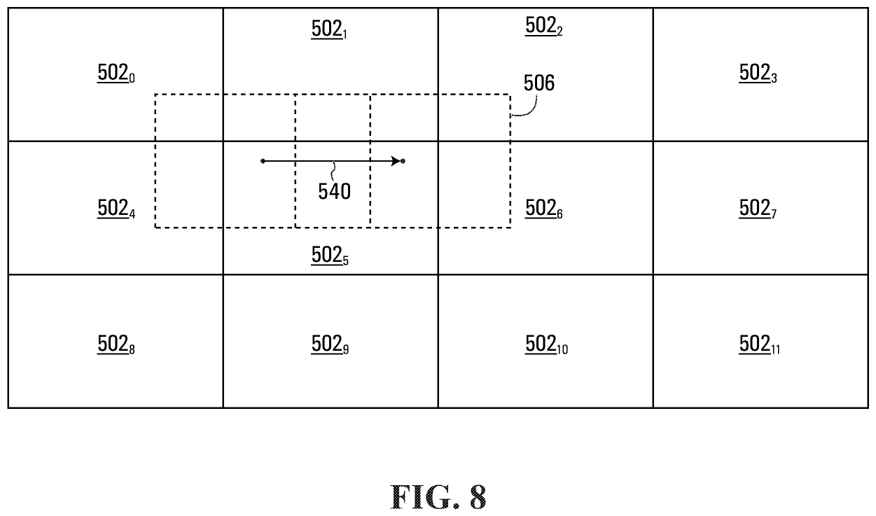

Reference will now be made to FIG. 8 which diagrammatically depicts a user pan movement where the ROI 506 moves from an original position shown in FIG. 6 to a new position. As shown in FIG. 8, translation arrow 540 depicts how the ROI 506 has moved. In the original position the ROI 506 was composed of four sub-regions corresponding to portions of the tiles 502₀, 502₁, 502₄ and 502₅; however in the new position the ROI 506 is composed of four different sub-regions corresponding to portions of the tiles 502₁, 502₂, 502₅ and 502₆. The impact of the pan movement on tile streaming is detailed in Table 3 below.

TABLE 3
Impact of Pan Movement Illustrated in FIG. 8

| Tile Reference | |
|---|---|
| Numerals (as | |
| Labelled in FIG. 8) | Tile Streamed? |
| 502₀ | Only in original position before pan movement. |
| 502₁ | Yes, both before and after pan movement. |
| 502₂ | Only in new position after pan movement. |
| 502₄ | Only in original position before pan movement. |
| 502₅ | Yes, both before and after pan movement. |
| 502₆ | Only in new position after pan movement. |

Thus, it can be seen from Table 3 that, with regards to tiles 502₁ and 502₅, these tiles may be streamed in high definition throughout the whole duration of the pan movement. By contrast, the other four tiles may be streamed in high definition at certain times but not at other times. For example, for the tiles 502₂ and 502₆, these tiles are not streamed before the pan movement. At the time of the pan movement, it may take time in order for tile streaming of the tiles 502₂ and 502₆ to be initialized and during such interim time placeholder video data derived from a lower resolution stream could be provided for the user to see until the high definition video data from the tiles 502₂ and 502₆ becomes available to present to the user. In other words, during the interim time described above the video shown to the user is hybridized until streaming of all four tiles begins (hybridized in the sense the user simultaneously sees both low resolution video corresponding to the tiles 502₂ and 502₆ and high resolution data corresponding to the tiles 502₁ and 502₅). Alternatively, during the interim time described above the video shown to the user could be all in low resolution until streaming of all four tiles begins, at which point the entirety of what the user sees switches from low resolution to high resolution.

Example embodiments may beneficially provide bandwidth reduction. For example, depending on the threshold for determining when to select low resolution video, the bandwidth reduction may be estimated to be 8-15%. How this 8-15% is arrived at explained below.

First, say one considers a device with twelve tiles in the full resolution ROL. Here the bandwidth reduction achieved by selecting four of these tiles for display is (given the same encoding bandwidth is closely correlated with resolution): 8/12=66.7%. Now if one assumes the ROI is at a threshold such that one can replace one of the four tiles with a low-resolution stream, the savings is: (320×240)/(1920×1080)=4% of tile bandwidth (where one assumes: tertiary resolution of 320×240, and tile resolution of 1920×1080). One can consider 4% as close to zero, so replacing any tile in the twelve tile representation with the tertiary low-resolution stream is approaching the efficiency achieved by not selecting the tile. In the twelve tile case, where ones replace one of the four tiles with a tertiary, it is as if one selected three tiles out of four. So a 9/12=75% reduction is achieved as compared with the 8/12=66.7% reduction previously stated for the no replacement scenario (or, in other words, an improvement of roughly 8%). If one replaces two of four tiles with a tertiary (instead of just one) we achieve the high end of the range in improvement (i.e. roughly 15%).

An impact of some example embodiments is that some older mobile devices may have difficulty showing multiple high definition video streams simultaneously due to hardware limitations such as processor and memory. By being able to selectively stream lower resolution video for some tiles (in which there is an ROI portion) older mobile devices can still stream multiple tiles and show high definition video for as much tiles as the hardware can support.

In accordance with at least one example embodiment, there is provided a video streaming application that can run on both new and old devices alike. Specifically, the video streaming application may support selecting how many streams are high definition if the mobile device cannot handle several.

In accordance with at least one example embodiment, improvement of dynamic performance of video recording hardware may be possible. For instance, a problem in the security domain is NVRs that run on commercial off-the shelf hardware that do not have the capacity to transcode for each and every potential mobile session. In accordance with at least one example embodiment, the server-side resource issue may be addressed by performing multi-encoding on the camera-side (with each alternate encoding for the same scene being a lower bandwidth representation) and then allowing the mobile computing device 104 make a selection of encoding(s) to stream that optimizes for quality of service within given network and device constraints.

Certain adaptations and modifications of the described embodiments can be made. For example, the client-side video review application 144 (FIGS. 1 and 3) may be downloadable software installed on the mobile computing device 104; however in some alternative example embodiments implementation of the UI and other parts of the client-side video review application 144 can be achieved with less installed software through the use of a browser application (e.g. one of the other applications 152 shown in FIG. 1). A browser application is a program used to view, download, upload, surf, and/or otherwise access documents (for example, mobile web pages). In some examples, the browser application may be the well-known Google® Chrome™ browser. Of course other types of browser applications are also equally possible including, for example, Safari™. The browser application reads pages that are marked up (for example, in HTML5). Also, the browser application interprets the marked up pages into what the user sees rendered as a page within the browser. The browser application could be run on the mobile computing device 104 to cooperate with software components on the server system 108 in order to enable a mobile device user to provide user input via the input devices 114 to control activity (for example, activity in relation to client-side video review). In such circumstances, the user of the mobile computing device 104 is provided with an alternative example user interface through which the user inputs and receives information in relation to video recordings and/or live video.

Therefore, the above discussed embodiments are considered to be illustrative and not restrictive, and the invention should be construed as limited only by the appended claims.

1. A surveillance system comprising:
a plurality of video security cameras;
a server system communicatively coupled to the video security cameras, the server system including a stream manager and at least one computer-readable storage device configured to store a plurality of video tiles combinable to form a larger portion or all of a high resolution video recorded by one of the video security cameras, and the stream manager being configured to:
process a request to stream at least a first video tile of the video tiles, and wherein the processing of the request by the stream manager includes:
determining a size of a first portion of a region of interest falling within the first video tile;
determining whether the size of the first portion is below a threshold size; and
initiating transmission of a first video stream over at least one network that includes at least one wireless communications path, the first video stream including the first video tile, and wherein the server system is configured to transmit the first video stream in: a first resolution when the size of the first portion is below the threshold size; and a second resolution when the size of the first portion is above the threshold size, and the second resolution being higher than the first resolution.

2. The surveillance system as claimed in claim 1 wherein both width dimension and height dimension of the region of interest are no greater than width dimension and height dimension respectively of any one of the plurality of video tiles.

3. The surveillance system as claimed in claim 1 wherein the stream manager is further configured to:
process another request to stream a second video tile of the video tiles, and wherein the processing of the another request by the stream manager includes:
determining a size of a second portion of the region of interest falling within the second video tile;
determining whether the size of the second portion is below the threshold size; and
initiating transmission of a second video stream over the at least one network, the second video stream including the second video tile, and wherein the server system is configured to transmit the second video stream in: the first resolution when the size of the second portion is below the threshold size; and the second resolution when the size of the second portion is above the threshold size.

4. The surveillance system as claimed in claim 3 wherein one of the first and second video tiles is transmitted in the first resolution and the other of the first and second video tiles is transmitted in the second resolution.

5. The surveillance system as claimed in claim 4 further comprising at least one mobile device configured to:
wirelessly receive the first and second video streams;
combine the first and second video streams into a composite video signal; and
display the composite video signal.

6. The surveillance system as claimed in claim 1 further comprising a mobile device configured to wirelessly receive the first video stream.

7. A method comprising:
storing a plurality of video tiles combinable to form a larger portion or all of a high resolution video;
processing a request to stream at least a first video tile of the video tiles, the processing including:
determining a size of a first portion of a region of interest falling within the first video tile;
determining whether the size of the first portion is below a threshold size; and
transmitting, over at least one network, a first video stream that includes the first video tile, and wherein the first video tile is transmitted in: a first resolution when the size of the first portion is below the threshold size; and a second resolution when the size of the first portion is above the threshold size, and the second resolution being higher than the first resolution.

8. The method as claimed in claim 7 wherein both width dimension and height dimension of the region of interest are no greater than width dimension and height dimension respectively of any one of the plurality of video tiles.

9. The method as claimed in claim 7 further comprising:
processing another request to stream a second video tile of the video tiles, the processing of the another request including,
determining a size of a second portion of the region of interest falling within the second video tile;
determining whether the size of the second portion is below the threshold size; and
transmitting, over the network, a second video stream that includes the second video tile, and wherein the second video tile is transmitted in: the first resolution when the size of the second portion is below the threshold size; and the second resolution when the size of the second portion is above the threshold size.

10. The method as claimed in claim 9 wherein one of the first and second video tiles is transmitted in the first resolution and the other of the first and second video tiles is transmitted in the second resolution.

11. The method as claimed in claim 10 further comprising:
receiving the first and second video streams at a mobile device;
combining, at the mobile device, the first and second video streams into a composite video signal; and
displaying the composite video signal on the mobile device.

12. The method as claimed in claim 7 wherein at least one network includes a wireless network providing a wireless communications path for the transmitted first video stream.

13. The method as claimed in claim 7 wherein at least one network includes at least one wireless network and at least one wired network.

14. The method as claimed in claim 7 further comprising receiving the first video stream at a mobile device.

15. A tangible, non-transitory, computer-readable storage medium deployable within a server system that acts on a plurality of video tiles such that the video tiles are combinable to form a larger portion or all of a high resolution video, and the computer-readable storage medium having instructions encoded therein, wherein the instructions, when executed by at least one processor, cause a carrying out of a method comprising:
processing a request to stream at least a first video tile of the video tiles, the processing including:
determining a size of a first portion of a region of interest falling within the first video tile;
determining whether the size of the first portion is below a threshold size; and
transmitting, over at least one network, a first video stream that includes the first video tile, and wherein the first video tile is transmitted in: a first resolution when the size of the first portion is below the threshold size; and a second resolution when the size of the first portion is above the threshold size, and the second resolution being higher than the first resolution.
